(19) United States
(12) Patent Application Publication
(10) Pub. No.: US 2007/0211693 A1
(43) Pub. Date: Sep. 13, 2007

(54) Control Of A Suspend State

(76) Inventors: Jani Hirsimaki, Tampere (FI); Kari O. Heikkila, Lempaala (FI)

Correspondence Address: HARRINGTON & SMITH, PC, 4 RESEARCH DRIVE, SHELTON, CT, 06484-6212, US

(21) Appl. No.: 10/582,658

(22) PCT Filed: Dec. 16, 2004
(86) PCT No.: PCT/FI04/00770

§ 371 Date: Feb. 16, 2007

(30) Foreign Application Priority Data
Dec. 19, 2003 (FI) 20031865

(51) Int. Cl. H04L 12/56

(52) U.S. Cl. 370/352; 370/310; 370/389

(57) ABSTRACT

The invention relates to a method for controlling a suspend state concerning a terminal device (MS) that is provided with both circuit-switched and packet-switched services by a communication network but that can only use: either the circuit-switched or the packet-switched service at a time. In a situation in which the terminal device (MS) enters into the suspend state in the packet-switched service in order to use the circuit-switched service, the method includes supplying information about the terminal device's (MS) entry into the suspend state to a gateway node of said communication network, such as a Gateway GPRS Support Node (GGSN) of a GPRS network.

### FIELD OF THE INVENTION

The invention relates to telecommunication networks that provide terminal devices with both circuit-switched and packet-switched services. Especially, but not exclusively, the invention concerns the handling of a General Packet Radio Service (GPRS) suspend state. Although a GPRS system is used as an example in the description part of the invention, the invention in its substantial parts can also be implemented, for example, in a third generation network such as a Wideband Code Division Multiple Access (WCDMA) network or in a comparable data transmission system.

### BACKGROUND OF THE INVENTION

In packet-switched data transmission information to be transmitted in a network is divided into small data units, called packets. The packets, which include the recipient's address information, are transmitted from a sender to a recipient by routing their path in the network on the basis of the recipient's address. In packet-switched data transmission the same radio resources can be divided among many different users as necessary.

Originally, GPRS is a packet-switched telecommunication service of the Global System for Mobile communications (GSM) network that supplements the existing services such as traditional circuit-switched data transmission and the Short Message Service (SMS). In conventional circuit-switched data transmission between wireless terminal device, such as a mobile station or a computer terminal, and a Base Station Subsystem (BSS) the reservation of radio resources typically takes place by reserving a so-called physical (radio) channel for the duration of the call, wherein the physical channel refers to an appointed time slot in a transmission frame in a specific frequency band. GPRS enables dynamic reservation of physical channels for data transmission. In other words, a physical channel is reserved for a certain MS-BSS link only when data is being transmitted. Thus unnecessary reservation of radio resources is avoided when there is no data to be sent.

Traditionally GPRS is intended to function together with the conventional circuit-switched data transmission of the GSM network in order to utilise the air interface efficiently for both data and speech communication. Therefore in its basic version GPRS uses the basic channel structure defined for GSM. In GSM a specific frequency band is divided on the time axis into a sequence of transmission frames known as Time Division Multiple Access (TDMA) frames. In GSM the defined length of the TDMA frame is 4.615 ms. Each TDMA frame is in turn divided into eight sequential time slots of equal length. When a call is started in the conventional circuit-switched transmission form, a physical channel is determined for the call in question by reserving a specific time slot (1-8) in each TDMA frame sequence. Physical channels for carrying various signalling in the network are defined in a corresponding way.

Radio resources for data transmission are reserved by appointing physical channels dynamically for either the circuit-switched or the packet-switched transmission form. As the network requirements for the circuit-switched transmission form are high, a large number of time slots can be reserved for that transmission form. On the other hand, when the demand for the GPRS transmission form is high, a large number of time slots can be reserved for that transmission form.

Terminal device that can only use either a circuit-switched or a packet-switched connection at the same time is termed class B GPRS terminal device. Thus, if the terminal device is in a circuit-switched operational mode (there is a circuit-switched call in progress in the terminal device, for example), it cannot send or receive packet-switched data, and vice versa. This causes a problem that will be illustrated in the following by reference to FIG. 1 describing some elements of a communication network that are used to implement circuit-switched and packet-switched services.

The main element of a network infrastructure in terms of GPRS services is a GPRS support node, which corresponds to a Mobile Switching Centre (MSC) of the GSM network, familiar in connection with circuit-switched data transmission. The GPRS support nodes of a GPRS network are divided into Serving GPRS Support Nodes (SGSNs) and Gateway GPRS Support Nodes (GGSNs). The SGSN is a support node that transmits data packets to terminal device MS and receives data packets transmitted by the terminal device MS through a base station subsystem BSS formed by base stations BTSs and base station controllers BSCs. Together with GPRS registers (not shown in the figure) the SGSN also maintains location data of terminal device moving in its service area in the GPRS network. Typically, the SGSN is physically implemented as a separate network element. The GGSN, which communicates with the SGSN, implements switching and joint operation with other networks, such as an Internet Protocol (IP) network 13. The reference number 12 refers to a server of the IP network, which can transmit packet-switched data to the terminal device MS (and receive data from the terminal device) over the GPRS network.

The mobile switching centre MSC provides the terminal device MS with circuit-switched services. The circuit-switched service may be a circuit-switched call to a telephone 11 in a Public Switched Telephone Network (PSTN), for example. The call is transmitted between the terminal device MS and the telephone 11 through the base station subsystem BSS and the MSC. It is also possible to access the IP network 13 from the PSTN. In some cases the radio interface between the terminal device MS and the base station subsystem BSS can be called a Um interface.

Let us now suppose that the terminal device MS is in a packet-switched GPRS operational mode and that it is in a TCP/IP (Transmission Control Protocol) connection with the server 12 of the IP network. The server 12 transmits packets the packet-switched operational mode, when the circuit-switched call ends. The circuit-switched call can last from a few seconds to tens (or even hundreds) of minutes. During the call the terminal device is in the GPRS suspend state. In such a case the TCP/IP connection suffers significantly, as the terminal device cannot send or receive packet-switched data while it is in the suspend state, in other words it cannot receive the TCP/IP packets sent by the server 12 or send TCP acknowledgement messages to the server.

Generally it is true for a TCP/IP connection that when a sender transmits TCP/IP packets to a recipient, a resend timer is set according to the TCP protocol. If acknowledgement messages do not arrive to the sender from the receiving end in a specified time, the resend timer expires. The TCP protocol takes care of the resending of unacknowledged TCP/IP packets to the recipient. In practice the resending is implemented in such a way that if the sender does not receive an acknowledgement/acknowledgements to a packet/packets transmitted, it:
doubles the value of the resend timer;
sets the size of the transmission window at 1 MSS (Maximum Segment Size); and
resends the first unacknowledged TCP/IP packet to the receiving end.

By restricting the size of the transmission window to 1 MSS in the resending it is ensured that a large amount of data is not sent to a bearer while its reception is not certain.

So when the terminal device MS enters into the GPRS suspend state when the circuit-switched call arrives, the resend timer of the server 12 expires, because the terminal device cannot send or receive packet-switched data while being in the suspend state, which means that the server 12 does not receive acknowledgement messages from the terminal device MS within the specified time. The server 12 now doubles the value of its resend timer, which initially may have been a few (TCP/IP packets) from the IP network 13 through the GGSN, the SGSN and the BSS to the terminal device according to TCP and IP protocols. The amount of data to be sent at a time is adjusted by the size of a transmission window. The sender of a TCP/IP packet uses an advertised window parameter (RWND) supplied by the recipient to determine the size of its transmission window (WND) together with a congestion window parameter (CWND), which congestion window parameter the sender itself in turn continually updates. The following comparison is used in the determination of the size of the transmission window (WND):
WND=MIN(CWND,RWND),
where the MIN function chooses the size of the transmission window according to the parameter (CWND or RWND) whose value is smaller at the time in question.

The server 12 can send one or more TCP/IP packets at a time. The terminal device MS acknowledges the packets received from the server 12 by sending TCP acknowledgement messages to the server according to a TCP protocol, which acknowledgement messages indicate to the server 12 which TCP/IP packets the terminal device MS has received.

Although the terminal device MS cannot send and receive circuit-switched data while being in the packet-switched operational mode, it can receive circuit-switched paging messages. Paging messages are signalling messages that are sent to terminal device as an indication of an incoming call to the terminal device.

Let us now suppose that a call is made from the PSTN telephone 11 to the terminal device MS, while it has an on-going TCP/IP connection with the server 12. In such a case the MSC sends a paging message to the terminal device. When the terminal device MS receives the paging message, it enters into a GPRS suspend state so that the user of the terminal device MS can answer the circuit-switched call. The terminal device will be transferred from the GPRS suspend state back to seconds, and resends the first unacknowledged TCP/IP packet (the size of the transmission window=1 MSS). If the circuit-switched call is still in progress, the server does not receive an acknowledgement to this TCP/IP packet either, so the resend timer expires once more. Again the server 12 doubles the value of the resend timer and sends the TCP/IP packet once again, and so on.

The resend timer can expire many times, until it reaches its maximum value, which may be some 60 seconds, for example. If the circuit-switched call is still in progress, the resending continues until the number of resendings reaches a predetermined upper limit, at which point the TCP/IP connection is aborted at the server 12 end. However, because the terminal device MS is still in the suspend state, the TCP/IP connection is only half closed. Such a situation represents an error situation for the TCP/IP connection.

When the circuit-switched call ends, the terminal device returns to the packet-switched operational mode (by a Resume procedure, for example), in which it can again send and receive packets of the TCP/IP connection. However, in the meantime, the TCP/IP connection may already have been aborted, which means that data that was transmitted earlier during the TCP/IP connection in question may be lost. Or, even if the TCP/IP connection had not been aborted (of half closed), an unnecessary additional delay will be caused before the normal sending of TCP/IP packets can start again. For example, if the resend timer has reached its maximum value, it may take as much as some 60 seconds before any sending of packets takes place. This is not optimal in terms of use of network resources.

It may also happen that the packets (or TCP segments) resent by the server during the suspend state may be unnecessarily carried to the terminal device after the terminal device has returned from the suspend state. The packets may have been in some buffer of the network, for example, and after the suspend state ends (resume) they then end up in the terminal device. By being unnecessarily carried it is here meant that the packets are unnecessarily carried to the terminal device, if the server has already closed the connection.

In a solution described in the patent application EP 1 161 036 A1, the above described problem is solved by controlling the size of the transmission window of the other connection party (e.g. the server 12) by the device that enters into a suspend state in such a way that the size of the transmission window is set to zero for the duration of the suspend state by a message sent to the other connection party by the device entering into the suspend state. Thus said other connection party will not try to send data unnecessarily during the suspend state. When the suspend state ends, another message is sent to said other connection party by the device that has returned from the suspend state. This message adjusts the size of the transmission window of the other connection party to some value other than zero, at which point the transmission of data continues from the other connection party to the device that has returned from the suspend state.

One weakness of the above described solution is that, for example, it is not fully certain that said message by which the size of the transmission window is set to zero arrives at its destination. Setting the size of the window suddenly to zero may also cause confusion in the TCP functions of said other connection party.

### SUMMARY OF THE INVENTION

The present invention aims at solving the above described problem caused by an entry into a suspend state in a more comprehensive manner. It has been observed in the invention that an advantage can be achieved if a specific network element or elements are informed of terminal device's entry into a suspend state.

According to a first aspect of the invention there is provided a method for controlling a suspend state of a packet-switched service concerning a terminal device that is provided with both circuit-switched and packet-switched services by a first communication network but which terminal device can only use either a circuit-switched or a packet-switched service at a time.

It is characteristic of the method that in a situation in which the terminal device enters into the suspend state in a packet-switched service in order to use a circuit-switched service, the method comprises:

supplying information about the terminal device's entry into the suspend state to a gateway node of said first communication network.

In one embodiment of the invention said packet-switched service is a packet-switched connection such as a TCP/IP or UDP/IP connection. According to one embodiment of the invention said terminal device is a class B GPRS terminal, but it may also be terminal device of a third or later generation system.

In embodiments of the invention a GGSN is informed of a GPRS suspension by network signalling or a specific message. When the GGSN has been informed of the suspend state of the terminal device, the GGSN can help prevent the abortion of a packet-switched link by sending a suitable message or messages to the other connection party, for example, in which case transmission by a TCP unit of said other connection party is prevented (or at least transmission is restricted) for the duration of the suspend state. Suitable messages may be Internet Control Message Protocol (ICMP) messages or Explicit Congestion Notification (ECN) messages, for example, depending on the implementation, or potentially some newer messages. Thus the packet-switched link can be kept in progress in a controlled way during the suspend state. Because transmission can be prevented (or at least restricted) for the duration of the suspend state, the suspend state requires less or no buffering of data.

In one embodiment of the invention a Wireless Application Protocol (WAP) gateway (a WAP proxy) is informed of the suspension of the terminal device. Such information provision can be implemented through a GGSN, for example, in which case the information received by the GGSN about the terminal device's suspend state can simply be forwarded to the WAP gateway.

According to a second aspect of the invention there is provided a communication device in accordance with claim 14.

According to a third aspect of the invention there is provided a network element in accordance with claim 16.

According to a fourth aspect of the invention there is provided a gateway node in accordance with claim 23.

According to a fifth aspect of the invention there is provided a system in accordance with claim 34.

According to a sixth aspect of the invention there is provided computer software executable in a network element in accordance with claim 35.

According to a seventh aspect of the invention there is provided computer software executable in a gateway node in accordance with claim 36.

Dependent claims include embodiments of the invention. The subject matter of dependent claims related to a specific aspect of the invention is also applicable to other aspects of the invention.

### BRIEF DESCRIPTION OF THE FIGURES

Embodiments of the invention are now described in an exemplary manner by reference to figures attached, wherein:

FIG. 1 shows elements of a communication network for implementing packet-switched and circuit-switched services;

FIG. 2 is a message diagram describing an embodiment of the invention;

FIG. 3 shows a terminal device according to an embodiment of the invention;

FIG. 4 shows a Serving GPRS Support Node (SGSN) in accordance with an embodiment of the invention;

FIG. 5 shows a Gateway GPRS Support Node (GGSN) in accordance with an embodiment of the invention; and

FIG. 6 illustrates one embodiment of the invention implemented in a Wireless Application Protocol (WAP) system.

### DETAILED DESCRIPTION

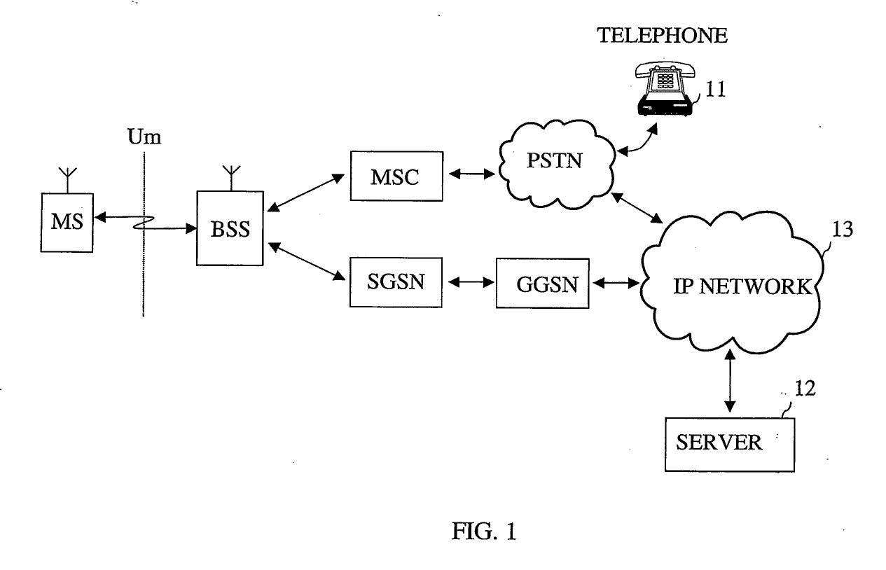

FIG. 1 has been explained in the foregoing in connection with the description of the prior art, but it will also be referred to in the following in connection with the description of the embodiments of the invention. GPRS is used as an example of communication over an air interface.

The IP network 13 shown in FIG. 1 can be an Internet or intranet network, among other things. Alternatively, it can be replaced by or connected to a GPRS network of another operator, some other wireless packet data network or another wired packet data network, such as an X.25 network.

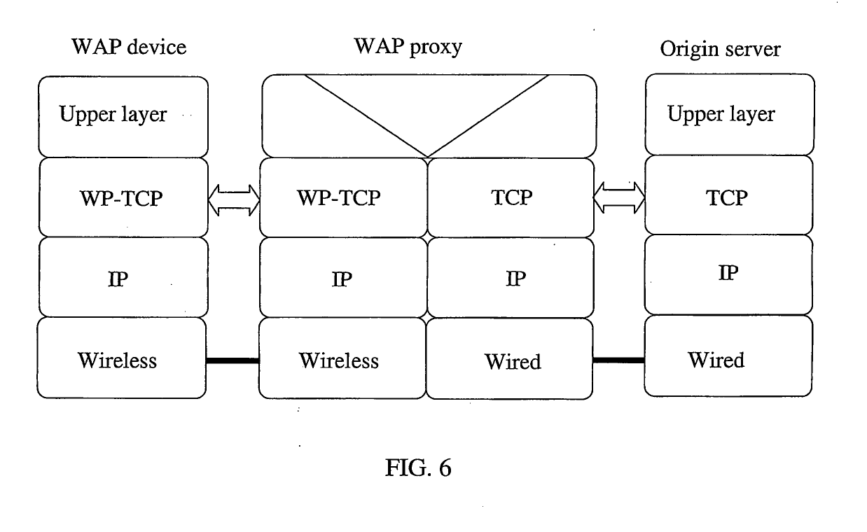

In a following embodiment of the invention the initial situation is as shown in FIG. 1, where terminal device MS is in a packet-switched GPRS operational mode and in a packet-switched connection, such as a TCP/IP or UDP/IP connection (User Datagram Protocol, the following focuses on a TCP/IP connection), with a server 12. In other words, GPRS is used as a bearer of a packet-switched connection. The connection of the terminal device MS and the other connection party (here: the server 12) is a so-called “direct connect” connection or a connection through a proxy/proxies. The present embodiment mainly focuses on “direct connect” connections. On the other hand, the embodiment shown in FIG. 6 mainly focuses on connections through a proxy.

In this embodiment of the invention the term terminal device MS refers to any device that comprises a TCP/IP protocol stack and that is capable of using GPRS protocols for external communication. The terminal device MS may be class B GPRS terminal device. Instead of the server 12, the other connection party may be a user terminal, such as a computer or another mobile communication device connected to a network 13. It should be noted that although the TCP/IP protocol stack is used as an example in this embodiment, the invention should not be restricted to the use of these protocols. For example, the invention can be applied to such class B GPRS terminal device that has no encoded TCP/IP stack and uses a dial-up connection, for example.

In the TCP/IP connection the server 12 transmits TCP/IP packets from the IP network 13 through a GGSN, an SGSN and a BSS to the terminal device according to TCP and IP protocols. The amount of data to be transmitted is adjusted at the sending end by the size of a transmission window. It is possible to send one or more TCP/IP packets at a time. The terminal device MS acknowledges the packets received from the server 12 by sending TCP acknowledgement packets according to the TCP protocol, the TCP acknowledgement packets indicating to the server 12 which packets the terminal device MS has received. As the TCP/IP connection is a two-way connection it is additionally or alternatively possible that the terminal device MS also sends TCP/IP packets to the server 12, which in turn acknowledges the packets received by TCP acknowledgement packets.

In the middle of a packet-switched connection (here: a TCP/IP connection) the terminal device MS receives information that it should transfer from a packet-switched operational mode to a circuit-switched operational mode.

The terminal device MS receives said information about entry into the circuit-switched operational mode, for example, when it receives a paging message (not shown) from an MSC that indicates an incoming circuit-switched call to the terminal device, such as a voice, data or fax call. In the example case of FIG. 1 said call is a voice call and it originates from a telephone 11 of a PSTN network. Alternatively, the terminal device receives information that it should transfer from the packet-switched to the circuit-switched operational mode when the user of the terminal device performs a specific action to initiate a circuit-switched connection from said terminal device to other terminal device while a packet-switched connection is on. Said action may be the initiation of a circuit-switched voice, data or fax call.

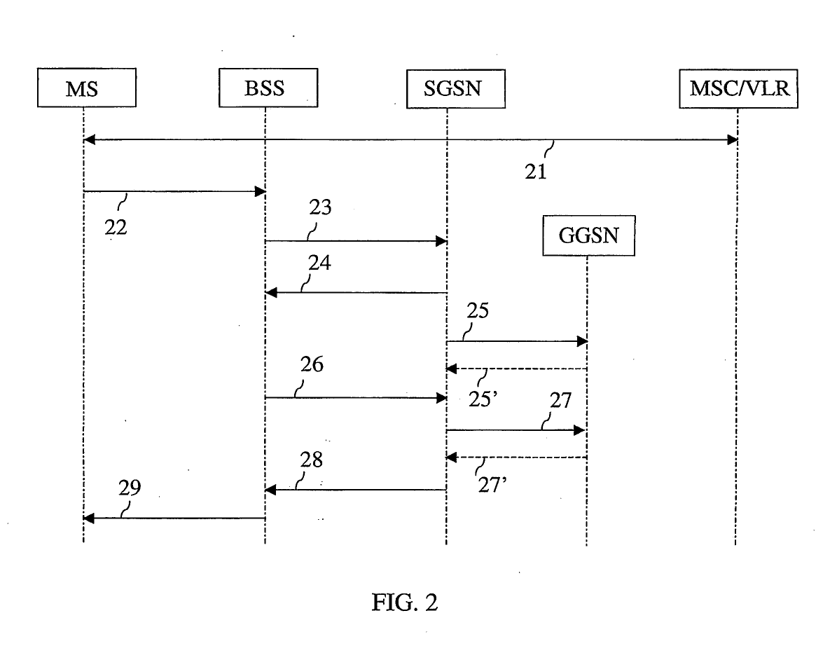

In the following reference is made to FIG. 2, which is a message diagram depicting one embodiment of the invention. When terminal device MS receives information that it should switch from a packet-switched to a circuit-switched operational mode, it enters into a dedicated mode to carry out the circuit-switched service. This is illustrated by a two-way arrow 21 between the terminal device and a Mobile Switching Centre/Visitor Location Register (MSC/VLR). At the same time the terminal device enters into a suspend state in the packet-switched mode. The suspend state can here be called and it has already been called a GPRS suspend state. Due to the entry into the suspend state the terminal device MS sends a message 22 to a base station subsystem BSS. Typically this message is a so-called “Suspend Message” or an equivalent. The “Suspend Message” 22 is transferred from the base station subsystem BSS to a Serving GPRS Support Node SSGN by a message 23, which is acknowledged by the SGSN by a message 24 (“Suspend Ack” or an equivalent).

In one embodiment of the invention information about terminal device's MS entry into a suspend state is supplied to a Gateway GPRS Support Node (GGSN). The information is supplied as a response to a message telling about the entry into the suspend state arriving at an SGSN. Depending on the implementation, the information can be supplied from the SGSN to the GGSN by network signalling or by a specific message 25. The GGSN can acknowledge the message 25 by an acknowledgement message 25′.

Alternatively or additionally the SGSN can receive the information about the circuit-switched call of the terminal device MS directly from an MSC through an interface Gs between the MSC and the SGSN. In this case, too, the SGSN informs the GGSN about the MS's entry into the suspend state.

After receiving the information about the terminal device's MS entry into the suspend state, the GGSN can prevent unnecessary transmission of data in a packet-switched TCP/IP connection (or an UDP/IP connection). It may contribute to the packet-switched connection not being aborted during the GPRS suspend state. The GGSN is an edge point of the GPRS network towards other networks (the network 13, for example), and it knows the IP address of the terminal device and the IP address with which the terminal device MS has an on-going packet-switched connection through the GGSN (here: the server 12). In order to prevent the server 12 from transmitting data to the terminal device MS during the suspend state (or at least to restrict it), the GGSN may, for example, transmit a suitable ICMP message/messages or an ECN message/messages to the address of the server 12. It must be noted that, depending on the implementation, there may be other ways (other messages, for example) for the GGSN to control said other connection party in terms of transmission of data. Due to the above-mentioned messages the other connection party that is located outside the GPRS network (here: the server 12) typically buffers data, because it cannot transmit it to the terminal device MS (or, more accurately, the terminal device MS cannot receive packet-switched data). In such a case its transmission window is typically reduced in proportion as new data is to be sent until it is reduced to zero in accordance with the normal operation of the TCP protocol. In other words, when said other connection party receives said messages, it restricts or even stops transmission, but it does not close the connection (here: the TCP connection).

When the use of circuit-switched services ends, the terminal device MS returns to the packet-switched operational mode by means of a Resume procedure or an equivalent. Typically this takes place as follows: after the use of the circuit-switched services has ended, the base station subsystem BSS first determines that the radio channel reserved for these services (for the terminal device MS) can be released. After this, the BSS requests the SSGN to return to the packet-switched service concerning the terminal device in question by a message 26 (“Resume”) (the terminal device returns to the packet-switched operational mode). The SSGN acknowledges the message 25 by an acknowledgement message 28 (“Resume Ack”). After this the BSS sends to the terminal device MS a message 29 (“Channel release”) that indicates to the terminal device that the circuit-switched radio channel is released. The terminal device MS leaves the dedicated mode.

In one embodiment of the invention information about the terminal device's MS return to the suspend state (“resume”) is supplied to the GGSN. The information is supplied as a response to the arrival of a message telling about the return from the suspend state to the SSGN. Depending on the implementation, the information can be supplied from the SSGN to the GGSN by network signalling or a specific message 27. The GGSN can acknowledge the message 27 by an acknowledgement message 27′.

After receiving the information about the return of the terminal device MS from the suspend state, the GGSN can perform restoring actions to restore the packet-switched connection to the normal state for the server 12 (=the other connection party). The message 27 can be sent either before the sending of the acknowledgement message or after it has been sent. If the message is sent before the acknowledgement message 28, the GGSN has more time to perform said actions. Depending on the implementation, the GGSN can, for example, send a suitable message to the server 12 to restore the situation created by an ICMP or ECN message (or messages) or it can simply stop sending the ICMP or ECN messages. It must be noted that, depending on the implementation, there may be other ways (other messages, for example) for the GGSN to control said other connection party in terms of the transmission of data at this stage.

When the packet-switched connection has been restored to the normal state for both the terminal device MS and the other connection party, the normal transmission/reception of packets can continue.

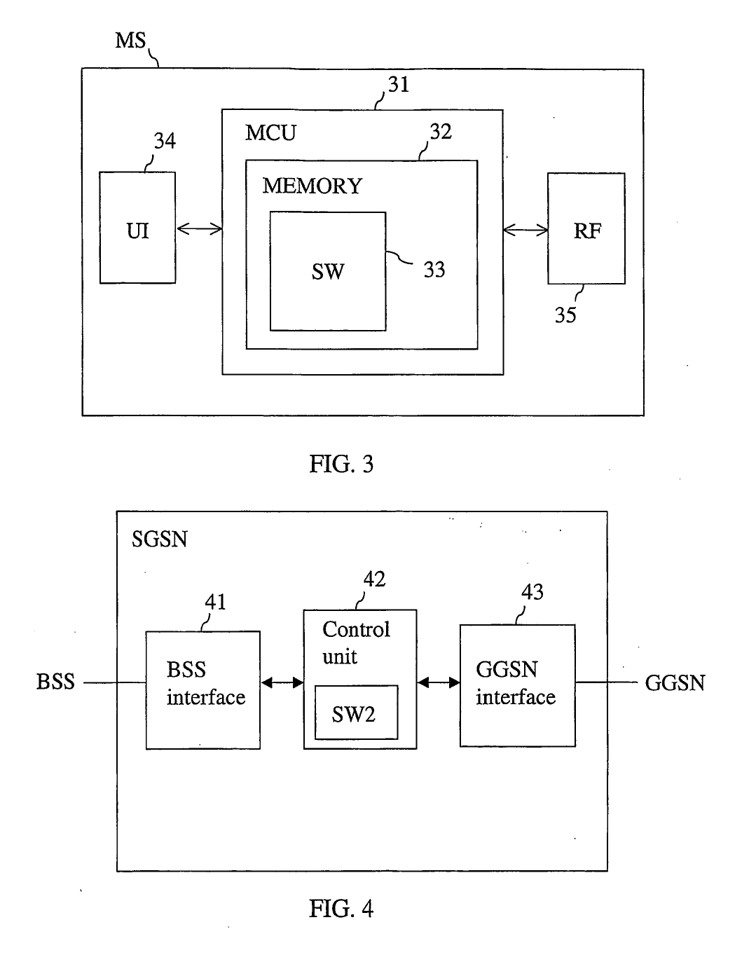

FIG. 3 shows terminal device MS according to an embodiment of the invention. The terminal device MS may be class B GPRS terminal device. The terminal device MS comprises a processing unit 31, a radio frequency section 35 and a user interface 34. The radio frequency section 35 and the user interface 34 are connected to the processing unit 31. The user interface 34 comprises a display, a keyboard, a loudspeaker and a microphone (not shown), by means of which a user can use the terminal device MS. The processing unit 31 comprises a processor (not shown) and a memory 32. The processor can be a microprocessor, a microcontroller or a digital signal processor, for example. The memory 32 comprises a non-volatile Read Only Memory (ROM) and a Random Access Memory (RAM). The radio frequency section 35 can transmit and receive radio frequency signals by its antenna (not shown) to and from a base station (not shown) of the base station subsystem BSS (FIG. 1) of a cellular network using both a circuit-switched and a packet-switched transmission mode.

Software 33 of the terminal device MS is typically stored in ROM. On the basis of the software the processor controls the operation of the terminal device MS, such as use of the radio frequency section 34, representation of messages on the user interface 34, and the reading of inputs received through the user interface 34. The processor uses the RAM memory as a temporary buffer memory when it processes information. The software is constructed of a set of program codes that may be built up in one computer program block or in different blocks of one computer program or they can be parts of a larger software unit. A protocol stack is stored in the memory comprising TCP/IP and GPRS protocols implemented by software. These protocols are used for transmitting and receiving packets through the radio frequency section.

The “Suspend message” presented above (message 22) is formed according to the GPRS protocols and sent to a base station subsystem BSS through the radio frequency section 35. The message 29 (“Channel release”) is in turn received through the radio frequency section 35 and it is processed in the terminal device by the software.

FIG. 4 represents an SSGN according to one embodiment of the invention. The SSGN comprises a control unit 42 that controls a BSS interface 41 and a GGSN interface 43 on the basis of software SW2 comprising program codes stored in said control unit 42 or in connection with it. Communication with a base station subsystem BSS takes place through the BSS interface. The “Suspend message” (message 23) and the “Resume message” (message 26) are received from the BSS and acknowledgements (messages 24 and 28) are sent to the BSS through that interface. Communication with a GGSN takes place through the GGSN interface. Network signalling/messages about terminal device MS entering into a suspend state and returning from the suspend state (messages 25 and 27) are sent and potential acknowledgements to these messages (messages 25′ and 27′) are received through that interface.

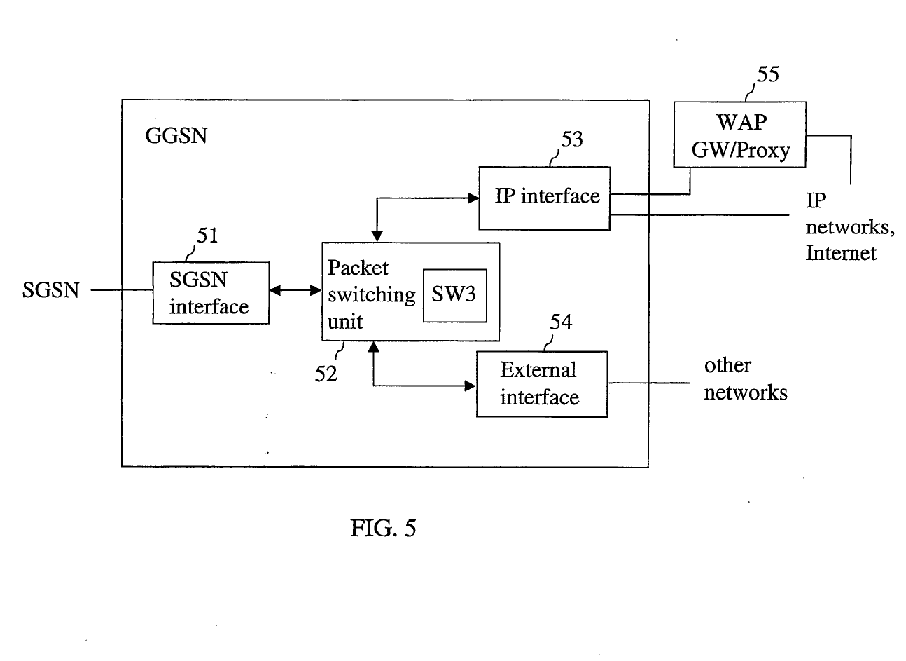

FIG. 5 shows a GGSN according to one embodiment of the invention. The GGSN comprises a packet switching unit 52, which can be thought to be operating as a control unit of the GGSN, an SSGN interface 51, an IP interface 53, and an external interface 54. The packet switching unit 52 controls the operation of the GGSN on the basis of software SW3 comprising program codes stored in the packet switching unit 52 or in connection with it. Communication with an SSGN takes place through the SSGN interface 51 and communication with other networks (networks listed in connection with the commentary on FIG. 1) takes place through the interface 54 (which has been drawn separately from the IP interface in FIG. 5 and which is here called the external interface 54). Communication with IP networks 13 takes place through the IP interface 53 either directly (the “direct connect” connections mentioned above) or through a WAP gateway/proxy 55 (the connections through a proxy mentioned above).

The packet switching unit 52 transfers data packets between terminal device MS and another connection party 12. The GGSN receives network signalling/messages sent by the SSGN about the terminal device's entry into a suspend state and returning from the suspend state (messages 25 and 27) and sends potential acknowledgements to these messages (messages 25′ and 27′). Through the IP interface 53 or the external interface 54 the GGSN can in turn send messages described in the embodiments of the invention towards the other connection party (reference number 12) that is in a packet-switched connection with the terminal device MS.

FIG. 6 illustrates an embodiment of the invention that can be implemented in a WAP system. In a WAP system such as WAP 2.0, WAP device is provided with a connection through a WAP gateway/proxy to a device that is here called an origin server. Alternatively the connection through the WAP gateway/proxy can be established to other WAP terminal device. Although the WAP gateway/proxy typically serves both as a gateway and a proxy, in the following it is only called a “WAP proxy”.

Using the terminology of FIG. 1 what is presented above means that terminal device MS is WAP device, which in this embodiment uses a WAP protocol stack implemented in the terminal device MS for external communication. The terminal device MS has a WAP session with the WAP proxy. The WAP session uses GPRS as a bearer in a radio interface Um between a base station subsystem BSS and the terminal device MS. The above mentioned connection provided to the terminal device MS can be, for example, a TCP connection through a GGSN and the WAP proxy to a server 12. As shown in FIG. 1, the server 12 can be located in a network outside the GPRS network (and possibly also outside the WAP gateway). The WAP gateway is logically located outside the GGSN. Physically it can in principle be implemented integrated in the GGSN, for example, or it can be located in a separate network element either in connection with the GGSN or outside the GPRS network, in a public IP network, for example.

According to WAP 2.0 the TCP connection from the terminal device MS to the server 12 can be implemented in such a way that there is a TCP connection between the terminal device MS and the WAP proxy that uses a Wireless Profiled TCP protocol (WP-TCP) and that there is a “normal” TCP connection between the WAP gateway and the server 12. The WP-TCP protocol corresponds to a normal TCP protocol, but it includes requirements/definitions by which the operation of the protocol is optimised specifically for a wireless environment. Upper layers implemented in the terminal device communicate directly with the upper layers of the server 12. In the protocol stacks of FIG. 6 there is also shown an IP layer, lower layers implemented in the terminal device MS and the WAP proxy (Wireless) and lower layers implemented in the WAP proxy and the server 12 (Wired).

When a GGSN according to an embodiment of the invention receives information about terminal device MS entering into a suspend state and starts sending, for example, ICMP or ECN messages through the IP interface 53 (FIG. 5), the WAP proxy 55 receives these messages. As a result, the WAP proxy stops sending WP-TCP connection packets towards the GPRS network (towards the GGSN), but a TCP unit of the WAP proxy, which communicates towards the server 12, continues to operate according to normal TCP operation. Thus it, for example, acknowledges data packets transmitted from the server 12 and addressed to the terminal device MS quite normally. However, because data included in these packets is not sent further to the terminal device MS during its suspend state, data is buffered at the WAP proxy 55. Because the TCP unit of the WAP proxy 55 buffers data, its reception window (an advertised window parameter sent to the server) can, according to the normal TCP operation, be reduced to zero. In such a case the transmission of data from the server 12 stops for the time being.

When information about the terminal device MS returning from the suspend state arrives at the GGSN data transmission both on the WP-TCP connection and the TCP connection between the WAP proxy 55 and the server 12 can be continued. Thus the consequences of the entry into the suspend state can be handled in a controlled manner in the TCP connection (and the WP-TCP connection), so that the connection is not aborted or half closed during the suspend state.

The terminal device MS can load XHTML/WAP (eXtensible HyperText Mark-up Language) page pictures from the server 12 through the WAP proxy 55. Alternatively or additionally it is possible to load multimedia messages from a multimedia message transfer server (not shown) or other such things through the WAP proxy 55. Related to these, the WAP proxy (or gateway) 55 may have timers for the duration of the TCP connection. When the information about the terminal device's entry into the suspend state arrives at the GGSN, it may exert an influence in a suitable manner (by a suitable message, for example) so that the timers of the WAP proxy will not expire (or so that the reaction to their expiry will not be abortion of the connection). In such a way the connection can be kept on during the suspend state, while it would otherwise have been aborted or half closed.

It must be noted that the above-mentioned WP-TCP can also be used in the above-mentioned “direct connect” connections, as described in the WP-TCP specification of WAP. In such a case the WP-TCP layer of the terminal device communicates directly with the TCP layer of the server.

Special implementations and embodiments of the invention have been described. It must be noted that although GPRS, TCP and WAP have been used in this description as examples, the invention can also be applied to other current and future systems, where the suspend-resume procedure or a procedure similar to it is used.

ECN and ICMP messages have been mentioned in the foregoing as examples that can be used in embodiments of the invention. It is clear to a person skilled in the art that alternatively other messages/methods of communication can be used. A Performance Enhanced Proxy (PEP), which can react to the messages in an appropriate way, can be implemented in connection with the WAP proxy.

It is clear to a person skilled in the art that the invention is not restricted to the details of the above described embodiments (the names of the messages or protocol layers, for example), but that it can be implemented in other embodiments using equivalent means without deviating from the characteristics of the invention. Only the claims attached restrict the scope of protection of the invention.

1. A method for controlling a suspend state of a packet-switched service concerning a terminal device that is provided with both circuit-switched and packet-switched services by a first communication network but which terminal device can only use either a circuit-switched or a packet-switched service at a time, wherein, in a situation in which the terminal device enters into the suspend state in a packet-switched service in order to use a circuit-switched service, the method comprises:
supplying information about the terminal device's entry into the suspend state to a gateway node of said first communication network.

2. A method according to claim 1, wherein the packet-switched service comprises implementing a packet-switched link between the terminal device and a second communication party outside the first communication network through said gateway node.

3. A method according to claim 2, wherein said second communication party is a server or a second terminal device.

4. A method according to claim 2, which comprises selecting said packet-switched link from a set comprising the following links: a Transmission Control Protocol (TCP) connection, a User Datagram Protocol (UDP) connection, a Wireless Profiled TCP (WP-TCP) connection.

5. A method according to claim 1, wherein the information about the terminal device's entry into the suspend state is supplied by using signalling or a specific message.

6. A method according to claim 1, wherein said gateway node is an edge point of the first communication network towards other networks, such as an Internet Protocol (IP) network.

7. A method according to claim 1, wherein said first communication network is a mobile communication network, such as a GPRS network.

8. A method according to claim 1, wherein said gateway node is a gateway support node of a packet radio network such as a Gateway GPRS Support Node (GGSN) of a General Packet Radio Service (GPRS) network.

9. A method according to claim 8, which comprises providing a serving support node of a packet radio network, such as a Serving GPRS Support Node (SSGN), with information about the terminal device's entry into the suspend state, and transferring this information to the gateway support node of the packet radio network by using signalling or a specific message.

10. A method according to claim 1, wherein said gateway node performs an action as a response to said information supplied to it.

11. A method according to claim 10, wherein said action comprises sending of a certain message, such as an Internet Control Message Protocol (ICMP) or an Explicit Congestion Notification (ECN) message, towards said second communication party in order to restrict or prevent the sending of packets.

12. A method according to claim 11, which comprises sending said message to a proxy, such as a Wireless Application Protocol (WAP) gateway/proxy.

13. A method according to claim 1, which method comprises:
supplying information about the terminal device's return from the suspend state, to the gateway node of said first communication network.

14. A communication device that is configured to use both circuit-switched and packet-switched services provided by a communication network, but which communication device can only use either a circuit-switched or a packet-switched service at a time, wherein, for a situation in which the communication device enters into the suspend state in a packet-switched service in order to use a circuit-switched service, the communication device is adapted to send information about the communication device's entry into the suspend state in order to supply said information to a gateway node of the communication network.

15. A communication device according to claim 14, which communication device is a mobile device configured to operate with a cellular communication network.

16. A network element of a first communication network for controlling a suspend state of a packet-switched service concerning a terminal device that is provided with both circuit-switched and packet-switched services by the first communication network, but which terminal device can only use either a circuit-switched or a packet-switched service at a time, wherein, for a situation in which the terminal device enters into the suspend state in a packet-switched service in order to use a circuit-switched service, the network element is adapted to supply information about the terminal device's entry into the suspend state to a gateway node of said first communication network.

17. A network element according to claim 16, wherein the packet-switched service comprises implementing a packet-switched link between the terminal device and a second communication party outside the first communication network through said gateway node.

18. A network element according to claim 17, wherein said link is selected from a set comprising the following connections: a TCP connection, a UDP connection, a WP-TCP connection.

19. A network element according to claim 16, which is adapted to supply the information about the terminal device's entry into the suspend state to the gateway node of the first communication network by using signalling or a specific message.

20. A network element according to claim 16, wherein said gateway node is an edge point of said first communication network towards other networks, such as an Internet Protocol (IP) network.

21. A network element according to claim 16, wherein said first communication network is a mobile communication network, such as a GPRS network.

22. A network element according to claim 16, which is a serving support node of a packet radio network, such as an SSGN of a GPRS network, which comprises a receiver for receiving the information about the terminal device's entry into the suspend state and a transmitter for transferring the information to a gateway support node of the packet radio network, such as a GGSN of the GPRS network.

23. A gateway node of a first communication network for controlling a suspend state of a packet-switched service concerning a terminal device that is provided with both circuit-switched and packet-switched services by the first communication network, but which terminal device can only use either a circuit-switched or a packet-switched service at a time, wherein, for a situation in which the terminal device enters into the suspend state in a packet-switched service in order to use a circuit-switched service, the gateway node comprises:
a receiver for receiving information about the terminal device's entry into the suspend state.

24. A gateway node according to claim 23, wherein the packet-switched service comprises implementing a packet-switched link between the terminal device and a second communication party outside the first communication network through said gateway node.

25. A gateway node according to claim 24, wherein said second communication party is a server or a second terminal device.

26. A gateway node according to claim 24, wherein said packet-switched link is selected from a set comprising the following connections: a TCP connection, a UDP connection, a WP-TCP connection.

27. A gateway node according to claim 23, which comprises a receiver for receiving signalling or a specific message telling about the terminal device's entry into the suspend state.

28. A gateway node according to claim 23, which gateway node is an edge point of the first communication network towards other networks, such as an Internet Protocol (IP) network.

29. A gateway node according to claim 23, wherein said first communication network is a mobile communication network, such as a GPRS network.

30. A gateway node according to claim 23, which is a gateway support node of a packet radio network, such as a Gateway GPRS Support Node (GGSN) of a General Packet Radio Service (GPRS) network.

31. A gateway node according to claim 23, which gateway node is adapted to perform an action as a response to the said information supplied to it.

32. A gateway node according to claim 31, wherein said action comprises sending of a specific message, such as an ICMP or ECN message, towards said second communication party in order to restrict or prevent the sending of packets.

33. A gateway node according to claim 32, which comprises sending said message to a proxy, such as a WAP gateway/proxy.

34. A system for controlling a suspend state of a packet-switched service concerning a terminal device, which system comprises said terminal device and a gateway node of a first communication network, which terminal device is provided with both circuit-switched and packet-switched services by the first communication network, but which terminal device can only use either the circuit-switched or the packet-switched service at a time, wherein, for a situation in which the terminal device enters into the suspend state in a packet-switched service in order to use a circuit-switched service, the terminal device comprises:
a transmitter for sending information about the terminal device's entry into the suspend state in order to supply said information to a gateway node of said first communication network, and which gateway node comprises:
a receiver for receiving the information about the terminal device's entry into the suspend state.

35. Computer software executable in a network element of a first communication network for controlling a suspend state of a packet-switched service concerning a terminal device that is provided with both circuit-switched and packet-switched services by the first communication network, but which terminal device can only use either a circuit-switched or a packet-switched service at a time, wherein, for a situation in which the terminal device enters into the suspend state in a packet-switched service in order to use a circuit-switched service, the computer software comprises:
program code causing the network element to supply information about the terminal device's entry into the suspend state to a gateway node of said first communication network.

36. Computer software executable in a gateway node of a first communication network for controlling a suspend state of a packet-switched service concerning a terminal device that is provided with both circuit-switched and packet-switched services by the first communication network, but which terminal device can only use either a circuit-switched or a packet-switched service at a time, wherein, for a situation in which the terminal device enters into the suspend state in a packet-switched service in order to use a circuit-switched service, the computer software comprises:
program code causing the gateway node to receive information about the terminal device's entry into the suspend state.
